(19) United States
(12) Patent Application Publication
(10) Pub. No.: US 2006/0019066 A1
(43) Pub. Date: Jan. 26, 2006

(54) Ornamental body and production method thereof

(75) Inventor: Shinichi Kajikawa, Hiroshima-shi (JP)

Correspondence Address: FRISHAUF, HOLTZ, GOODMAN & CHICK, PC, 220 5TH AVE FL 16, NEW YORK, NY, 10001-7708, US

(73) Assignee: Nishikawa Rubber Co., Ltd., Hiroshima-shi (JP)

(21) Appl. No.: 11/170,133

(22) Filed: Jun. 29, 2005

(30) Foreign Application Priority Data
Jul. 26, 2004 (JP) JP2004-217726

(51) Int. Cl. B32B 3/00

(52) U.S. Cl. 428/141; 428/156

(57) ABSTRACT

There is provided an ornamental body 1 whose surface is provided with a process to get a texture similar to sued surface by a shot blasting process, a process to buff surface or an embossing roller process, for forming fine concavities and convexities. The surface of the ornamental body 1 is provided with irradiation of laser beams 501 after completion of the process to get a texture similar to sued surface, thereby capably forming a emboss pattern design.

### BACKGROUND OF THE INVENTION

This invention relates to an ornamental body which is improved in design by processes provided on a surface of a rubber material, a thermoplastic resin material, or a rubber and thermoplastic resin material which forms the ornamental body.

There have conventionally been provided ornamental processes on a surface of a rubber material in manufacturing a rubber product in order to improve its design.

For example, as illustrated in FIG. 6, there is provided a shot blasting process on a surface of the opening seal portion 14 of the weather strip 10 for an automobile by blasting tiny glass pieces or metal pieces on the surface in order to obtain a texture similar to suede surface (“a texture similar to suede surface” is a fluff of surface).

Further, there has been provided a process of forming a emboss pattern design on a surface of a weather strip for an automobile. There is a known method in the process, besides a method of pressing a roll which is provided with a emboss pattern, in which laser beams are irradiated on a surface of a weather strip for an automobile thereby forming the emboss pattern design (see, for example, Japanese Unpublished Patent Publication No. 11-99887).

There are disclosed mainly two methods in the Japanese Unpublished Patent Publication No. 11-99887. A first method is such that laser beams are irradiated to a weather strip before it is vulcanized, followed by a process of vulcanization of the weather strip, thereby forming a emboss pattern design produced by a difference in a degree of foaming of a sponge rubber between a portion which is irradiated by the laser beams and a portion which is not irradiated by the laser beams.

A second method is such that laser beams are irradiated to a weather strip after it is vulcanized. The surface of the weather strip which will be provided with an ornamental process is made of a non-black colored rubber. And, the surface of the weather strip is provided with an emboss pattern design by a differentiation of the color between a portion which is burned by the irradiation of the laser beams and a portion which is not irradiated.

In the above-mentioned prior arts, they may be improved in design by forming the emboss pattern design on the surface on which a process to get a texture similar to suede surface has been completed. However, in doing so, they have problems as raised below.

In the method of pressing the roll which is provided with the emboss pattern in order to form the emboss pattern design, it is hardly able to form a emboss pattern design on a curved surface, and further it is required to prepare a various types of rolls in order to form different types of emboss pattern designs. Therefore, the operation of the embossing becomes troublesome.

Further, according to the first method disclosed in the Japanese Unpublished Patent Publication No. 11-99887, the emboss pattern design is formed by irradiating the laser beams to the surface of the rubber material before the rubber material is vulcanized. And then, there is provided a process to get a texture similar to suede surface with e.g., the shot blasting on the emboss pattern design.

According to this method, the previously formed emboss pattern design will disappear by the shot blasting process, remaining merely the texture similar to suede surface. Therefore, it is unable to form the emboss pattern design on the surface on which the process to get a texture similar to suede surface is performed at last.

Further, according to the second method disclosed in the Japanese Unpublished Patent Publication No. 11-99887, although it is possible to form the emboss pattern design by irradiating the laser beams to the rubber material after completion of the vulcanization, it is required to use the non-black colored rubber materials, so that rubber materials usable in this method is limited.

It is therefore an object of this invention to provide an ornamental body which is provided with a design such as a emboss pattern design on a surface thereof which has been provided with a process to get a texture similar to suede surface.

### SUMMARY OF THE INVENTION

In order to solve the problems raised above, there is provided an ornamental body (1) according to a first aspect of the invention which is characterized in that it comprises a base material made of rubber, thermoplastic resin, or rubber and thermoplastic resin, wherein a surface of the base material is provided with a process to get a texture similar to suede surface forming fine concavities and convexities. A design is formed on the texture similar to suede surface by irradiating laser beams (501) on the surface after completion of the process to get a texture similar to suede surface.

According to a second aspect of the invention there is provided an ornamental body which is characterized in the first aspect of the invention, wherein the process to get a texture similar to suede surface for forming fine concavities and convexities on the surface of the ornamental body (1) is performed by a shot blasting process, a process to buff surface or an embossing roller process.

It should be noted that in this invention, either one of the shot blasting process, the process to buff surface and the embossing roller processes can be applied, or two or three of the processes can be applied in combination.

According to a third aspect of the invention, there is provided an ornamental body which is characterized in the first or second aspect of the invention, wherein the design is a emboss pattern design.

According to a fourth aspect of the invention, there is provided an ornamental body which is characterized in the first, second or third aspect of the invention, wherein the ornamental body (1) is a constructional element of an external surface of a weather strip (10) for an automobile.

According to a fifth aspect of the invention, there is provided an ornamental body which is characterized in the first, second or third aspect of the invention, wherein the ornamental body (1) is a constructional element of a top board portion (25) of a gasket (20) for a joint of an external wall.

In this invention, the gasket (20) is a long-made member and it is inserted into a joint opening (50) formed between construction boards (30, 30), and is comprised of a pole portion (21) made of rubber or rubber-like elastic body, and seal lip portions (22, 23, 24) formed in the left and right sides of the pole portion (21). The gasket (20) seals the joint opening (50).

According to a sixth aspect of the invention, there is provided an ornamental body which is characterized in any of the first to the fifth aspects of the invention, wherein at least the surface layer of the base material is made of sponge material.

According to a seventh aspect of the invention, there is provided a production method of an ornamental body which is characterized in that it comprises processes of vulcanizing a base material made of a rubber material; providing a process to get a texture similar to suede surface forming fine concavities and convexities on a surface of the base material; and, forming a design on the texture similar to suede surface by irradiating laser beams (501) on the surface after completion of the process to get a texture similar to suede surface.

According to an eighth aspect of the invention, there is provided a production method of an ornamental body which is characterized in that it comprises processes of extrusion molding an ornamental body (1) comprising a base material made of rubber, thermoplastic resin, or rubber and thermoplastic resin; providing a process to get a texture similar to suede surface on a surface of the base material forming fine concavities and convexities; and, forming a design on the texture similar to suede surface by irradiating laser beams (501) on the surface after completion of the process to get a texture similar to suede surface.

According to a ninth aspect of the invention, there is provided a production method of an ornamental body which is characterized in that it comprises processes of extrusion molding a base material made of a rubber material; vulcanizing the base material; providing a process to get a texture similar to suede surface on a surface of the base material whose surface layer at least is made of sponge rubber, forming fine concavities and convexities on the sponge rubber; and, forming a design on the texture similar to suede surface by irradiating laser beams (501) on the surface after completion of the process to get a texture similar to suede surface.

According to a tenth aspect of the invention, there is provided a production method of an ornamental body characterized in any of the seventh to the ninth aspects of the invention, wherein the process to get a texture similar to suede surface for forming fine concavities and convexities on a surface of the ornamental body is performed by a shot blasting process, a process to buff surface or an embossing roller process.

According to an eleventh aspect of the invention, there is provided a production method of an ornamental body which is characterized in any of the seventh to the tenth aspects of the invention, wherein a silicon or urethane coating is applied on the surface after the design is formed on the surface.

It should be noted that each numeral in each parenthesis indicates a corresponding element or matter disclosed in the after-mentioned preferred embodiment of the invention or the drawings.

According to the invention, the design is formed on the texture similar to suede surface by the laser beams after completion of the process to get a texture similar to suede surface which forms the fine concavities and convexities on the surface of the ornamental body, so that the process to get a texture similar to suede surface comes first, and that the design formed after completion of the process to get a texture similar to suede surface is not erased. Therefore, there can be provided a design on the surface of the ornamental body after completion of the process to get a texture similar to suede surface.

In this invention, in order to differentiate the surface in colors and irregularity, there is induced a contrast between the laser beamed portion and the peripheral portion similar to suede surface by irradiating the laser beams on the surface on which the process to get a texture similar to suede surface has already been done for producing the concavities and convexities as well as burnt on the surface.

Therefore, unlike the first method disclosed in the Japanese Unpublished Patent Publication No. 11-99887, the design is not formed by the irradiation of the laser beams prior to the vulcanization, so that the irradiation of the laser beams can be performed only after completion of the process to get a texture similar to suede surface. Further, unlike the second method disclosed in the Japanese Unpublished Patent Publication No. 11-99887, it is unneeded to use a non-black colored rubber as a material of the ornamental body, so that color of the ornamental body is not limited.

Further, according to the invention, any design can be formed by controlling the laser beams by a computer and the like with irradiation patterns designed by such as CAD.

Further, according to the invention, the process to get a texture similar to suede surface is performed by the shot blasting process, the process to buff surface or the embossing roller process, so that any process can be selected from them depending on a shape of the ornamental body subjected to the process, a degree of the process to get a texture similar to suede surface and the like.

Further, according to the invention, the emboss pattern design is formed on the surface of the ornamental body, so that the design on the surface formed by the process to get a texture similar to suede surface can be improved by an effect of the emboss pattern design.

Further, according to the invention, the ornamental body, on which the process to get a texture similar to suede surface is applied and the design such as the emboss pattern design is formed, is applied to the exterior surface of the weather strip for an automobile, so that a portion of the weather strip easily viewed from an outside is improved in its design.

Further, according to the invention, the ornamental body, on which the process to get a texture similar to suede surface is applied and the design such as the emboss pattern design is formed, is applied to the top board portion of the gasket for a joint of an external wall, so that a portion of the gasket easily viewed from an outside is improved in its design.

Further, according to the invention, the silicon or the urethane coating is applied to the surface of the ornamental body, on which the process to get a texture similar to suede surface has been applied and the design such as the emboss pattern design has been formed, so that the surface can be polished up, and that the design on the surface can be prevented from a change in color and from being stained.

### BRIEF DESCRIPTION OF THE DRAWINGS

FIG. 1 is a perspective view showing a weather strip for an automobile comprising an ornamental body according to a first preferred embodiment of the invention;

FIG. 2 is a drawing showing a manufacturing process of the weather strip for an automobile shown in FIG. 1;

FIG. 3 is a drawing showing a laser beam irradiation process in the manufacturing process shown in FIG. 2;

FIG. 4 is a perspective view showing a gasket for a joint of an external wall comprising an ornamental body according to a second preferred embodiment of the invention is inserted into a space formed between construction boards;

FIG. 5 is an ornamental body according to a third aspect of the invention;

and, FIG. 6 is a perspective view showing a weather strip for an automobile according to a prior art.

### DESCRIPTION OF PREFERRED EMBODIMENT

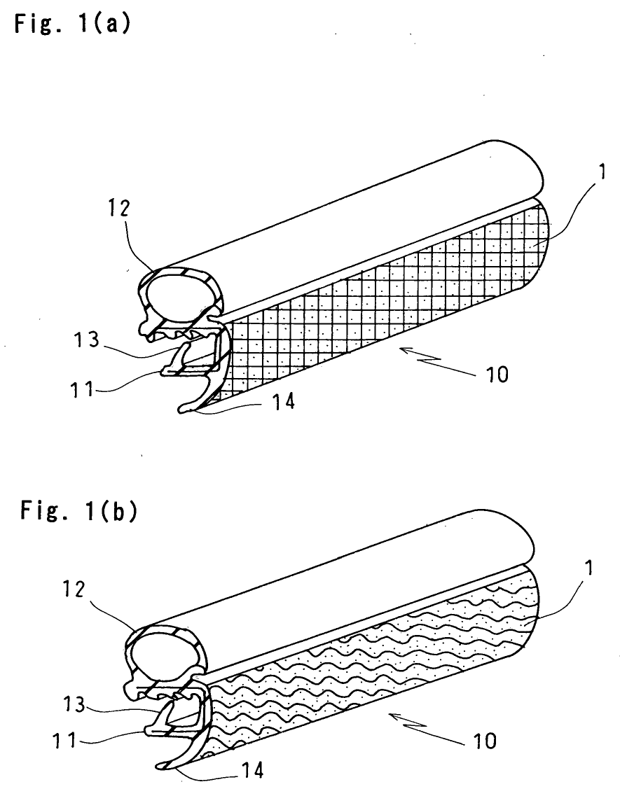

An ornamental body according to a first preferred embodiment of the invention will be described referring to FIGS. 1 to 3.

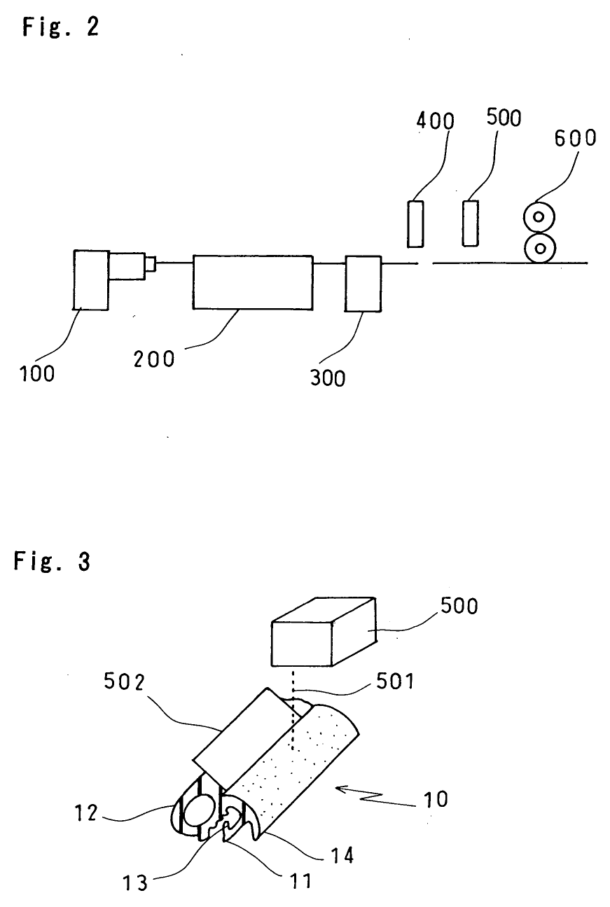

FIG. 1 is a perspective view showing a weather strip 10 for an automobile comprising the ornamental body 1 according to the first preferred embodiment of the invention. FIG. 2 is a drawing showing a manufacturing process of the weather strip 10 which is illustrated in FIG. 1. FIG. 3 is a drawing showing a laser beam irradiation process by a laser beam irradiation device 500 which is illustrated in FIG. 2.

First, a constructional structure of the ornamental body 1 according to the first preferred embodiment of the invention will be described.

As illustrated in FIG. 1, the ornamental body according to the first preferred embodiment of the invention is used as a constructional element of an opening seal portion 14 of the weather strip 10 for an automobile.

The weather strip 10 for an automobile comprises an installation base portion 11 which is installed to an opening edge of an automobile body by a holding lip portion 13, a hollow seal portion 12 which is integrally formed with the installation base portion 11 making a resilient contact with such as a door which counter faces the hollow seal portion 12, and an opening seal portion 14 which is also integrally formed with the installation base portion 11.

The opening seal portion 14 is a portion which is particularly viewed after the weather strip is installed to an automobile body. The surface of the opening seal portion 14 is provided with a process to get a texture similar to suede surface as well as a emboss pattern design.

It should be noted that FIG. 1 illustrates a type of emboss pattern as indicated by “(a)” on which a checkerboard design is applied, and a type of emboss pattern as indicated by “(b)” on which wavy lines are applied.

Secondly, a production method of a weather strip 10 comprising the ornamental body 1 according to the first preferred embodiment of the invention will be described.

As illustrated in FIG. 2, the production method according to the first preferred embodiment of the invention is performed with an extrusion molding device 100, a vulcanization device 200, a pulling device 300, a processing device to get a texture similar to suede surface 400, a laser beam irradiation device 500 and a coating device 600.

The weather strip 10 after extrusion molding by the extrusion molding device 100 is vulcanized by the vulcanization device 200 and then it is pulled in by the pulling device 300.

Then, the surface of the opening seal portion 14 of the weather strip 10 is provided with the process to get a texture similar to suede surface by the processing device to get a texture similar to suede surface 400.

The process to get a texture similar to suede surface can be done by a shot blasting process which blasts tiny glass pieces or metal pieces, a process to buff surface which forms concavities and convexities on the surface by rubbing, or an embossing roller process. The process to get a texture similar to suede surface can be performed by either one of those processes, or it can be done with a combination of two or three of the mentioned processes.

Then, as illustrated in FIG. 3, the opening seal portion 14 after completion of the process to get a texture similar to suede surface is subjected to an irradiation of laser beams 501 by the laser beam irradiation device 500, forming a emboss pattern design on the surface. An irradiation pattern of the laser beam 501 is freely alterable by controlling with e.g., a computer.

In the irradiation of the laser beams 501, it is desirable to cover the hollow seal portion 12 with the hollow seal masking 502 in order to irradiate the opening seal portion 14 only.

It is desired to use CO₂ laser as the laser beam used in this irradiation.

At last, a silicon or urethane coating is applied on the surface of the opening seal portion 14, on which the emboss pattern design has been formed, by the coating device 600.

According to the weather strip 10 for an automobile comprising the ornamental body 1 according to the preferred embodiment of the invention, the surface of the opening seal 14 of the weather strip 10 comprising the ornamental body 1 is irradiated by the laser beams 501 using the laser beam irradiation device 500 after it is provided with the fine concavities and convexities by the process to get a texture similar to suede surface using the processing device to get a texture similar to suede surface 400, thereby forming the emboss pattern design on the surface. Since the process to get a texture similar to suede surface is performed prior to the irradiation of the laser beams 501, the emboss pattern design which is formed after the process to get a texture similar to suede surface does not disappear. Therefore, it is possible to form the emboss pattern design on the surface of the opening seal portion 14 which has been provided with the process to get a texture similar to suede surface in advance.

The method of forming the emboss pattern design according to the first preferred embodiment of the invention is such that there is induced a contrast in colors and irregularity between the portion the laser beams are irradiated and the peripheral portion similar to suede surface the laser beams are not irradiated, by providing the concavities and convexities as well as the burnt on the surface of the opening seal 14 with the process of irradiation of the laser beams 501 on the surface of the opening seal portion 14 which has been provided with the process to get a texture similar to suede surface.

Therefore, unlike the first method disclosed in the Japanese Unpublished Patent Publication No. 11-99887, the emboss pattern design is not formed by the irradiation of the laser beams 501 before the vulcanization with the vulcanization device 200, so that the irradiation of the laser beams with the laser beam irradiation device 500 can be performed after completion of the process to get a texture similar to suede surface with the processing device to get a texture similar to suede surface 400, and that the emboss pattern design formed by the process to get a texture similar to suede surface does not disappear.

In addition, the emboss pattern design is formed by the contrast in colors and irregularity between the portion the laser beams 501 are irradiated and the peripheral portion similar to suede surface, so that unlike the second method disclosed in the Japanese Unpublished Patent Publication No. 11-99887, it is unneeded to use non-black colored rubber, and that the color of the ornamental body used is unlimited.

Further, the emboss pattern design formed on the opening seal portion 14 can be freely selected by controlling the irradiation pattern of the laser beams 501 with a computer and the like.

The process to get a texture similar to suede surface according to the first preferred embodiment of the invention is performed by the shot blasting process, the process to buff surface or the embossing roller process, so that any process can be selected depending on a shape of the opening seal portion 14 subjected to the process, the degree of the process to get a texture similar to suede surface and the like.

Further, in the first preferred embodiment of the invention, the design formed on the surface of the opening seal portion 14 is the emboss pattern design, so that with a combination of the texture similar to suede surface and the emboss pattern design, the design can be further improved.

Further, the ornamental body 1 according to the first preferred embodiment of the invention is used as a constructional element of the opening seal portion 14 which forms an external surface of the weather strip 10 for an automobile, so that a portion of the weather strip 10 easily viewed from an outside can be improved in its design.

Further, the surface of the opening seal portion 14 provided with the process to get a texture similar to suede surface and the emboss pattern design is coated with the silicon or urethane coating by the coating device 600, so that the surface can be polished up, and that the emboss pattern design is prevented from being discolored and stained.

In the first preferred embodiment of the invention, although there is introduced that the process to get a texture similar to suede surface is performed by the shot blasting process, the process to buff surface or the embossing roller process, it is not limited to such process, and it can be done with any other processes which are capable of performing the process to get a texture similar to suede surface.

Further, in the first preferred embodiment of the invention, although the ornamental body 1 is applied to the opening seal portion 14 of the weather strip for an automobile, it can be applied to any external surface of the weather strip 10 for an automobile, and it, for example, can be applied to the hollow seal portion 12.

Moreover, the application of the silicon or urethane coating by the coating device 600 is not an essential process, and without this process, it is possible to form the emboss pattern design on the surface of the opening seal portion 14 which has been provided with the process to get a texture similar to suede surface.

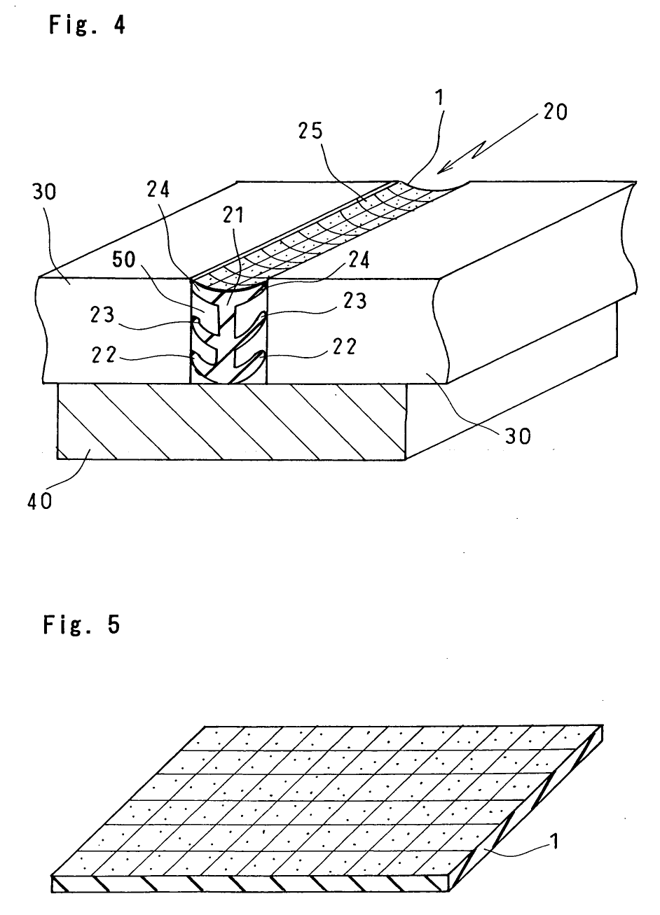

Referring to FIG. 4, an ornamental body according to a second preferred embodiment of the invention will be described.

FIG. 4 is a perspective view showing a gasket 20 for a joint of an external wall comprising the ornamental body 1 according to the second preferred embodiment of the invention, which is inserted into a space formed between the construction boards 30, 30.

First, the constructional structure of the ornamental body 1 according to the second preferred embodiment of the invention will be described.

As illustrated in FIG. 4, the ornamental body 1 of this embodiment is used as a constructional element of the top board portion 25 of the gasket 20 for a joint of the external wall.

The gasket 20 is a long-made member and is inserted into the joint space 50 formed between the construction boards 30, 30. The gasket 20 comprises a pole portion 21 made of a rubber or rubber-like elastic body, and seal lip portions 22, 23, 24 provided at the left and right sides of the pole portion 21 for sealing the joint space 50.

A production method of the gasket 20 for a joint of an external wall comprising the ornamental body 1 according to the second embodiment of the invention is similar to the production method disclosed in the first preferred embodiment of the invention. It should be noted that in the second preferred embodiment, the top board portion 25 of the gasket 20 is provided with the process to get a texture similar to suede surface and the emboss pattern design.

According to the gasket 20 for a joint of an external wall comprising the ornamental body 1 in the second preferred embodiment of the invention, the ornamental body 1 provided with the emboss pattern design is applied to the top board portion 25 of the gasket 20, so that a portion of the gasket 20 easily viewed from an outside can be improved in its design.

Particularly, by appropriately combining the design of the top board portion 25 and a design of the construction boards 30, 30 provided adjacent to the top board portion 25, the design of the area can be further improved.

As a base material of the ornamental body, rubber, thermoplastic resin, or rubber and thermoplastic can be used.

As a quality of material of the rubber, there can be used, for example, natural rubber, styrene-butadiene rubber (SBR), chloroprene rubber (CR), nitrile rubber (NBR), ethylene-propylene rubber (EPM), ethylene-propylene-diene monomer rubber (EPDM), etc. As an ornamental body for a weather strip for an automobile or for a gasket of a joint of an external wall, it is preferable to use EPDM from the view point of weather resistance.

Further, as a quality of material of the thermoplastic resin, there can be used, for example, thermoplastic orefinic elastomer (TPO), styrene-based thermoplastic elastomer (TPS), urethane-based thermoplastic elastomer (TPU), etc. As an ornamental body for a weather strip for an automobile or for a gasket of a joint of an external wall, it is preferable to use TPO or TPS from the view point of low cost.

It is preferable to form the surface layer of the base material with sponge material in order to apply the process to get a texture similar to suede surface.

The ornamental body according to the first and second preferred embodiments of the invention has been described above taking the particular examples. The invention, however, is not limited to an application in the weather strip for an automobile or the gasket for a joint of an external wall.

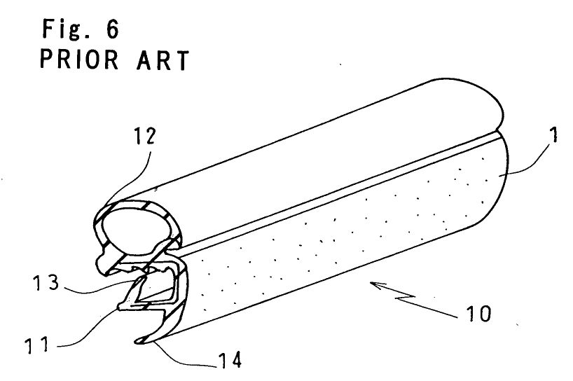

Therefore, as illustrated in FIG. 5 as a third preferred embodiment of the invention, there can be prepared a merely flat ornamental body 1 with an improved design, in which the surface thereof is provided with a design by providing the process to get a texture similar to suede surface and the irradiation of laser beams after completion of the process to get a texture similar to suede surface. The ornamental body 1 made of rubber material, thermoplastic resin material, or rubber and thermoplastic resin material can be applied to any surfaces of any products for the aim of providing an ornamental process on the surfaces.

Further, according to the first to the third aspects of the inventions, although the design applied on the surface of the ornamental body 1 is the emboss pattern design, other designs, besides the emboss pattern design, as such that comprises words, figures and the like can be formed by changing the irradiation pattern of the laser beams 501.

1. An ornamental body comprising a base material made of rubber, thermoplastic resin, or rubber and thermoplastic resin, wherein:
a surface of said base material is provided with a process to get a texture similar to suede surface forming fine concavities and convexities,
and, a design is formed on the said processed surface by irradiating laser beams on said processed surface after completion of said process to get a texture similar to a suede surface.

2. An ornamental body as claimed in claim 1, wherein said process to get a texture similar to a suede surface forming fine concavities and convexities on said surface of said ornamental body is performed by a shot blasting process, a process to buff surface or an embossing roller process.

3. An ornamental body as claimed in claim 1, wherein said design is a emboss pattern design.

4. An ornamental body as claimed in claim 1, wherein said ornamental body is a constructional element of an external surface of a weather strip for an automobile.

5. An ornamental body as claimed in claim 1, wherein said ornamental body is a constructional element of a top board portion of a gasket for a joint of an external wall.

6. An ornamental body as claimed in claim 1, wherein at least a surface layer of said base material is made of sponge material.

7. A production method of an ornamental body, comprising:
vulcanizing a base material made of a rubber material;
providing a process to get a texture similar to a suede surface forming fine concavities and convexities on a surface of said base material;
and, forming a design on said processed surface by irradiating laser beams on said processed surface after completion of said process to get a texture similar to a suede surface.

8. A production method of an ornamental body, comprising:
extrusion molding an ornamental body comprising a base material made of rubber, thermoplastic resin, or rubber and thermoplastic resin;
providing a process to get a texture similar to a suede surface on a surface of said base material forming fine concavities and convexities;
and, forming a design on said processed surface by irradiating laser beams on said processed surface after completion of said process to get a texture similar to a suede surface.

9. A production method of an ornamental body, comprising:
extrusion molding a base material made of a rubber material;
vulcanizing said base material; providing a process to get a texture similar to a suede surface on a surface of said base material whose surface layer at least is made of sponge rubber, forming fine concavities and convexities on said sponge rubber;
and, forming a design on said processed surface by irradiating laser beams on said processed surface after completion of said process to get a texture similar to a suede surface.

10. A production method of an ornamental body as claimed in claim 7, wherein said process to get a texture similar to a suede surface forming fine concavities and convexities on the surface of said ornamental body is performed by a shot blasting process, a process to buff surface or an embossing roller process.

11. A production method of an ornamental body as claimed in claim 7, wherein silicon or urethane coating is applied on the surface after said design is formed on said surface.

12. A production method of an ornamental body as claimed in claim 10, wherein silicon or urethane coating is applied on the surface after said design is formed on said surface.

13. A production method of an ornamental body as claimed in claim 8, wherein said process to get a texture similar to a suede surface forming fine concavities and convexities on the surface of said ornamental body is performed by a shot blasting process, a process to buff surface or an embossing roller process.

14. A production method of an ornamental body as claimed in claim 13, wherein silicon or urethane coating is applied on the surface after said design is formed on said surface.

15. A production method of an ornamental body as claimed in claim 8, wherein silicon or urethane coating is applied on the surface after said design is formed on said surface.

16. A production method of an ornamental body as claimed in claim 9, wherein said process to get a texture similar to a suede surface forming fine concavities and convexities on the surface of said ornamental body is performed by a shot blasting process, a process to buff surface or an embossing roller process.

17. A production method of an ornamental body as claimed in claim 16, wherein silicon or urethane coating is applied on the surface after said design is formed on said surface.

18. A production method of an ornamental body as claimed in claim 9, wherein silicon or urethane coating is applied on the surface after said design is formed on said surface.

19. An ornamental body as claimed in claim 2, wherein said design is a emboss pattern design.

20. An ornamental body as claimed in claim 3, wherein said ornamental body is a constructional element of an external surface of a weather strip for an automobile.

21. An ornamental body as claimed in claim 2, wherein said ornamental body is a constructional element of an external surface of a weather strip for an automobile.

22. An ornamental body as claimed in claim 2, wherein said ornamental body is a constructional element of a top board portion of a gasket for a joint of an external wall.

23. An ornamental body as claimed in claim 2, wherein at least a surface layer of said base material is made of sponge material.
